(19) United States
(12) Patent Application Publication
(10) Pub. No.: US 2007/0208780 A1
(43) Pub. Date: Sep. 6, 2007

(54) Apparatus, system, and method for maintaining metadata for offline repositories in online databases for efficient access

(76) Inventors: Matthew Joseph Anglin, Tucson, AZ (US); Kenneth Eugene Hannigan, Tucson, AZ (US); Mark Alan Haye, Tucson, AZ (US)

Correspondence Address: Kunzler & McKenzie, 8 EAST BROADWAY, SUITE 600, SALT LAKE CITY, UT, 84111, US

(21) Appl. No.: 11/366,343

(22) Filed: Mar. 2, 2006

(51) Int. Cl. G06F 17/30

(52) U.S. Cl. 707/200

(57) ABSTRACT

An apparatus, system, and method are disclosed for maintaining metadata for offline repositories in online databases for efficient access. In one embodiment the apparatus includes a metadata module configured to maintain metadata pertaining to one or more data record copies of a data record. At least one of the one or more data record copies is stored in an offline storage medium. The apparatus further comprises a query processor module configured to retrieve metadata pertaining to the one or more data record copies in accordance with the metadata stored in the metadata module.

### BACKGROUND OF THE INVENTION

1. Field of the Invention

This invention relates to the maintenance of automated and manual file restoration devices and more particularly relates to tracking metadata for one or more backup copies of a file and delaying the deletion of the metadata related to the file until all backup copies of the file have been deleted.

2. Description of the Related Art

Large and small enterprises create backups of critical files on a regular basis. System administrators and information technology (IT) administrators design backup systems and schedules to ensure that copies of important files are preserved on a regular basis, for example daily, weekly or monthly. As part of a disaster recovery plan, administrators may create multiple copies of each backup file for storage at a plurality of locations that are separated geographically. For example, a bank in Boston, Mass. may store backup files in Cambridge, Mass. and in Los Angeles, Calif. as part of a strategic data preservation plan.

Backup files may be stored in computer accessible, online repositories or in computer inaccessible offline repositories. Frequently, virtual storage systems track the location of online file copies while ignoring the existence and location information for offline file copies. The deletion of an online backup copy of a file may result in the deletion of all tracking information related to the file, despite the fact that an offline copy of the file may exist.

By deleting an online copy of a file and the associated tracking information, the location information for an offline copy may be lost. The nature of the file and the fact that the file ever existed may also be lost, making the offline file copy virtually worthless. In order to discover the contents of offline files, an administrator may need to mount the volume containing the offline files and bring the contents of the volume into an online repository. Loading the contents or index of an offline volume into online storage is a time consuming process that would not be necessary if a copy of the index of the offline volume had been preserved.

From the foregoing discussion, it should be apparent that a need exists for an apparatus, system, and method that maintain metadata for offline repositories in online databases for efficient access of the offline files in the offline repositories. Beneficially, such an apparatus, system, and method would assist administrators to carry out disaster recovery and avoid the need to sort through offline repositories to read the contents and indices of offline volumes. Additionally, such an apparatus, system, and method would greatly increase the efficiency of access to offline files.

### SUMMARY OF THE INVENTION

The present invention has been developed in response to the present state of the art, and in particular, in response to the problems and needs in the art that have not yet been fully solved by currently available backup storage systems. Accordingly, the present invention has been developed to provide an apparatus, system, and method for maintaining metadata for offline repositories in online databases for efficient access to data in the offline repositories that overcome many or all of the above-discussed shortcomings in the art.

The apparatus to maintain metadata for offline repositories in online databases for efficient access is provided with a plurality of modules configured to functionally execute the necessary steps of maintaining online metadata of offline repositories. These modules in the described embodiments include one or more copies of a data record, a metadata module, and a query processor module. At least one copy of the data record is stored on an offline storage medium. The metadata module is configured to maintain metadata related to the one or more data record copies. The query processor module is configured to retrieve the metadata pertaining to the one or more data record copies.

The apparatus, in one embodiment, further comprises a record creation module configured to notify the metadata module of record creation events and the deletion module is configured to notify the metadata module of record deletion events.

The apparatus may further be configured to increment a count of the number of copies of the data record in response to receiving a record creation event, decrement the count of the number of copies of the data record in response to receiving a record deletion event, and delete the metadata in response to decrementing the count to zero.

In a further embodiment, maintaining metadata comprises tracking the one or more copies of the data record and deleting the metadata pertaining to the one or more data record copies in response to the deletion of the last copy of the data record.

The apparatus may be configured to maintain metadata pertaining to files stored on computer tapes, compact discs (CDs), digital video discs (DVDs), removable hard disks, floppy disks, universal serial bus storage devices, and the like.

A signal bearing medium tangibly embodying a program of machine readable instructions executable by a digital processing apparatus to perform an operation to retrieve data from a plurality of data repositories is also presented. The operation in the disclosed embodiments substantially includes the steps necessary to carry out the functions presented above with respect to the operation of the described apparatus. In one embodiment, the operation includes maintaining an online and an offline repository of data records, maintaining an online metadata entry associating one or more copies of a data record, wherein at least one of the one or more copies is maintained in the offline repository

In a further embodiment, the operation includes updating the online metadata entry in response to the deletion of a copy of the data record and deleting the metadata entry in response to the deletion of the last copy of the data record.

A computer program product including a computer usable program for deploying a computer program product and computer usable code for executing the computer program product is also the presented. The computer program product comprises modules that substantially execute the steps necessary to carry out the functions presented above with respect to the operation of the signal bearing medium.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system in accordance with the present invention;

FIG. 2 is a schematic block diagram illustrating a backup system in accordance with the present invention;

FIG. 3 is a schematic block diagram illustrating three repositories in accordance with the present invention;

FIG. 4 is a schematic block diagram illustrating a metadata database in accordance with the present invention;

FIG. 5A is a schematic flow chart diagram illustrating one embodiment of a method to maintain metadata in accordance with the present invention;

FIG. 5B is a schematic flow chart diagram illustrating one embodiment of an expanded view of one of the functions of the method of FIG. 5A;

FIG. 6 is a schematic flow chart diagram illustrating one embodiment of an expanded view of one of the functions of the method of FIG. 5A; and

FIG. 7 is a schematic flow chart diagram illustrating one embodiment of an expanded view of one of the functions of the method of FIG. 5A.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

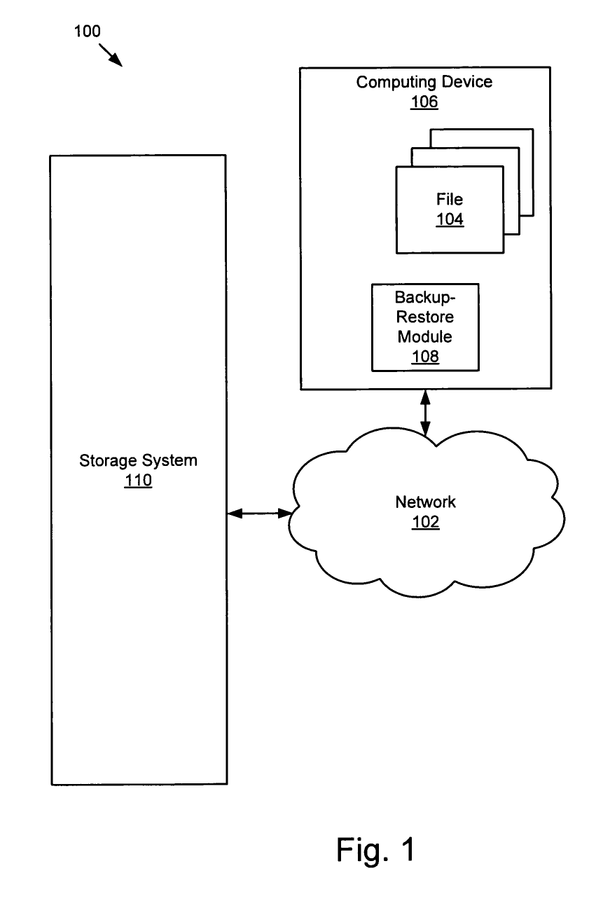

FIG. 1 illustrates one embodiment of a system 100 for maintaining metadata for offline repositories in an online database for efficient access. The system is designed to maintain one or more copies of a data record. In one embodiment, the system is used to manage one or more copies of backup files. Computer administrators and computer users frequently desire to backup files from one computer system to a storage system 110. The storage system 110 may provide both a storage medium for file copies as well as a storage management to facilitate file system backups and restoration. The storage system 110 may maintain a plurality of versions for a backed up file. In some cases, one or more of the backup files may be stored in an offline repository. The storage system 110 maintains an online metadata database of the backed up files to facilitate rapid access to the offline files and to track file location information as well as creation times for each file.

In another embodiment of the invention, the system 100 may maintain one or more cached copies of a file and may use an online metadata database to track information pertaining to the various file copies. Those of skill in the art will understand that systems 100 of the present invention need not track backup files. For example, a system 100 may track cached files, virtual storage system files, and the like without departing from the spirit of the present invention.

In addition, the storage system 110 may maintain a plurality of copies of one version of a backed up file stored on different types of media and in different geographic locations. Some file copies may be stored online while other file copies may be stored offline. Differentiating between an online and offline data is a relative distinction. An online copy is immediately accessible to a computer system while an offline copy is not immediately accessible. The temporal difference in access times varies from one computer system and from one application to another. In one system, an online record may be a record stored in the electronic random access memory (RAM) of the computer system or on a hard disk or optical drive attached to the computer system.

An offline record for the same system may be stored on a computer tape or optical disk that must be manually mounted in order to access its data. An offline record may also be stored on a compact disc (CD), a digital video disc (DVD), a hard drive, a removable hard disk, a floppy disk, a universal serial bus storage device, and the like. However, those of skill in the art will understand that the distinction between online and offline data records may be modified according to the temporal data access capabilities of the computing system and the temporal data retrieval requirements placed upon the system. Such a distinction may affect the design and implementation of a storage system 110 consistent with the spirit of the present invention.

Some systems use automated robots for mounting computer tapes and/or optical disks, reducing the time needed to access data stored on such a media. Those of skill in the art will understand that a spectrum of accessibility exists for storage medium from data stored in the cache of a computer system to data stored on a remote storage medium requiring manual intervention to facilitate data access. For purposes of this application, an online record is one that may be accessed electronically by a computer system without human intervention including data records that may be accessible across a storage area network (SAN) or other computer network and data records that may be accessed with the assistance of a programmatically controlled robot or tape access system. An offline record, on the other hand, requires human intervention to physically insert a storage medium into a drive, reader, or other device before a computer system may access data on the medium. In addition, an offline record may be stored on a medium that must be transported from a storage facility to a computing center prior to insertion in a storage device reader.

The system 100 may comprise a storage system 110, a network 102, and one or more computing devices 106. The storage system 110 may contain logic and hardware necessary to receive and complete backup requests, initiate and complete backup operations, and receive and service restore requests. The storage system 110 may comprise computer hardware and software configured to store backup files. The storage system 110 may also comprise storage facilities including storage closets for computer tapes, racks, and the like. The storage system 110 may include hardware, software, media, and facilities necessary to effect online and offline storage of backup files.

A computing device 106 may comprise a central processing unit (CPU), a RAM, an operating system, a local hard disk, an optical storage device, other storage devices, and a network interface. The computing device 106 may create files 104 in RAM as well as files 104 on a hard disk or local storage devices. The computing device 106 may comprise a backup-restore module 108. The computing device 106 may comprise hardware and software capable of communicating with the storage system 110 over the network 102.

A system administrator or a user of a computing device 106 may schedule a backup of a single file 104, a group of files 104 or all of the files 104 under the control of the computing device 106. The computing device 106 issues backup and restore commands through the backup-restore module 108 which communicates with the storage system 110 to accomplish backup and restore operations.

The network 102 may comprise a storage area network (SAN), a local area network (LAN), a wide area network (WAN), the Internet, a direct connection using a fibre channel, ribbon cable, or other connection that allows the computing device 106 to communicate with the storage system 110. The network 102 may comprise a single network 102 or a plurality of networks 102 linked together by hubs, switches, routers, and other networking devices.

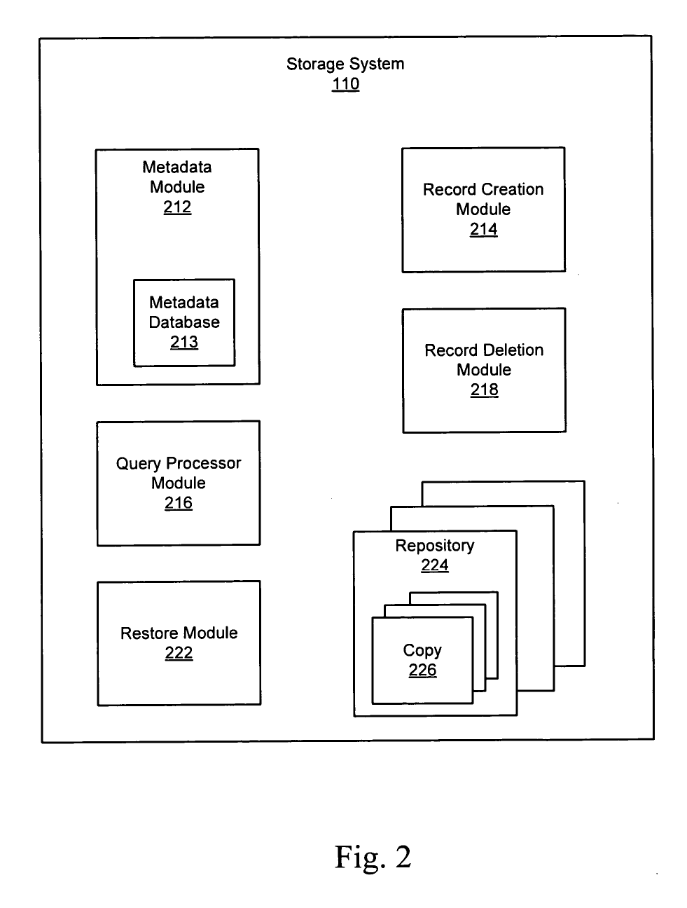

FIG. 2 illustrates one embodiment of a storage system 110 of the present invention. The storage system 110 may comprise various modules including a metadata module 212, a record creation module 214, a query processor module 216, a record deletion module 218, a restore module 222, and one or more repositories 224 comprising various copies 226 of files 104.

The metadata module 212 maintains and manages an online metadata database 213. The metadata database 213 tracks metadata for the various copies 226 of a file 104. The storage system 110 may store a plurality of versions of the same file 104 as well as a plurality of copies 226 of each version. The metadata module 212 tracks the various copies including filename, versioning information, backup date, location of the copy 226 and the like. The storage system 110 relies upon the metadata module 212 to accurately maintain the status of all file copies 226. Some metadata may relate to file copies 226 that are stored remotely, either in a remote archive, or in the custody of a system administrator or a user of a computing device 106.

The record creation module 214 processes the creation of new backup copies 226. For example, if a system administrator executes a weekly backup of a computing device 106, a copy 226 is sent to the storage system 110. The actual copy 226 is stored in a repository 224. However, the record creation module 214 processes the record creation and notifies the metadata module 212 of the particulars related to new copy 226 including the filename, the creation date, version information, the location medium pertaining to the copy 226, and the like. Record creation may result from a backup initiated by a backup-restore module 108 in a computing device 106 or by a command issued or scheduled to run in the storage system 110. Record creation may be scheduled to occur nightly, weekly, monthly, or at other time intervals.

The query processor module 216 processes requests by system administrators and users for the current status of file copies 226. For example, a user may query the storage system 110 for the latest version of a word processing file 104. The query processor module 216 queries the metadata module 212 to discover the number of copies 226 available for restoration, and the versions and dates associated with each file 104. Because the metadata module 212 stores current information for online and offline files 104, the query processor module 216 does not need to query the repositories 224 for current information.

The record deletion module 218 processes record deletion notifications and updates the metadata module 212 as appropriate. Periodically, a backup copy 226 may be deleted from one or more of the repositories 224. A system administrator may schedule the expiration and the deletion of backup copies 226 on a regular schedule. In one embodiment, the administrator may move backup copies 226 that are more than one month old to an offline and geographically remote repository 224 in preparation for a disaster. The record deletion module 218 also tracks the movement of backup copies 226. In the event of a disaster that destroys a primary online repository 224, the storage system 110 utilizes metadata information maintained by the metadata module 212 to locate remote backup copies 226. The function of the record deletion module 218 ensures the proper maintenance of metadata related to currently available backup copies 226.

The restore module 222 processes restoration requests from system administrators and users. A restoration request typically requests a copy 226 of a file 104. A restoration request may request the latest copy 226 of a file 104 or a date specific copy 226. A system administrator may request a restoration of a single file 104 following an inadvertent file deletion, the restoration of an entire file system following the destruction of an online repository 224, the restoration of a single computing device 106 following a hard drive crash, or the restoration of dozens of systems following the destruction of an entire computing center.

The restore module 222 communicates with the metadata module 212 to locate the desired backup copies 226 and delivers those copies 226 to the designated destination computing system. In some cases, the desired copy 226 exists in an online repository 224 and the copy 226 may be restored quickly. In other cases, the desired copy 226 exists only in an offline copy 226. The restore module 222 utilizes the online metadata database 213 of the metadata module 212 to efficiently access the desired copy 226. The restore module 222 may generate a work order to cause the appropriate archive volume to be retrieved from an offline repository 224.

In the case of a network outage, the storage system 110 may create individual backup tapes for physical delivery to individual users to assist in the restoration of individual computing devices 106. The backup-restore module 108 in each computing device 106 may comprise logic to restore backup copies 226 from an individual backup tape as well as logic to restore a backup copy 226 over the network 102 directly from the storage system 110.

The metadata module 212 tracks the location and status of all backup copies 226 in the online metadata database 213. The metadata module 212 does not delete metadata for a specific file 104 until all copies 226 have been deleted. The metadata module 212 communicates with the record deletion module 218 to ensure that the metadata module 212 does not inadvertently delete metadata associated with offline copies 226.

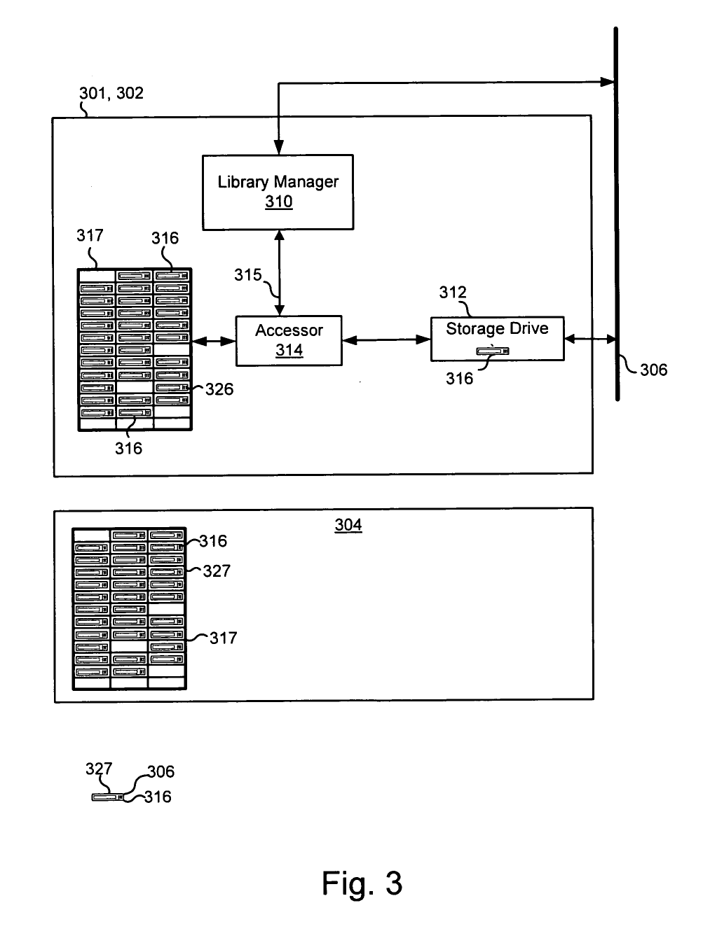

FIG. 3 illustrates the embodiments of different types of repositories 224: an online repository 301, an offline repository 304, and a single copy repository 306. The online repository 301 illustrated depicts a robot-assisted online repository 302 comprising a library manager 310, a robotic tape accessor 314, a storage bin 317 for storing computer accessible computer tapes 326, and a storage device 312. The robot-assisted online repository 302 communicates with the storage system 110 via a SAN 308 or a similar communications means such as ESCON and FICON. The library manager 310 processes file access requests and directs the robotic tape accessor 314 to mount a specific computer tape 316 from the storage bin 317 into the storage device 312. A robotic tape accessor 314 may also access other media types including optical disks. A typical robot-assisted online repository 302 may comprise a plurality of storage devices 312 to allow simultaneous access to multiple computer tapes 316. A robot-assisted online repository 302, although not strictly an online repository 224, provides rapid access to backup files 104 stored on computer tapes 316.

The offline repository 304 comprises a storage bin 317 of computer inaccessible computer tapes 327. The offline repository 304 may be located on the same campus as the logic modules of the storage system 110 or alternatively may be located at a remote site as part of a data preservation strategy. An administrator may need to transport the computer tape 316 of the offline repository 304 to computing center with a storage device 312 and may further need to manually insert the computer tape 316 into the storage device 312. The metadata module 212 tracks the status of file copies 226 contained on the computer inaccessible computer tape 327 of the offline repository 304 in its online metadata database 213.

The single copy repository 306 represents a single computer inaccessible computer tape 327. Some individual users may keep a storage bin 317 with their computing device 106 to allow personal data recovery. Alternatively, the single computer tape 316 of the single copy repository 306 may be a restoration copy sent to an individual user. The backup-restore module 108 of the computing device 106 may comprise specialized logic to restore files 104 from an individual computer tape 316. The metadata module 212 tracks the location and status of all file copies 226 located in all types of offline and online repositories 224.

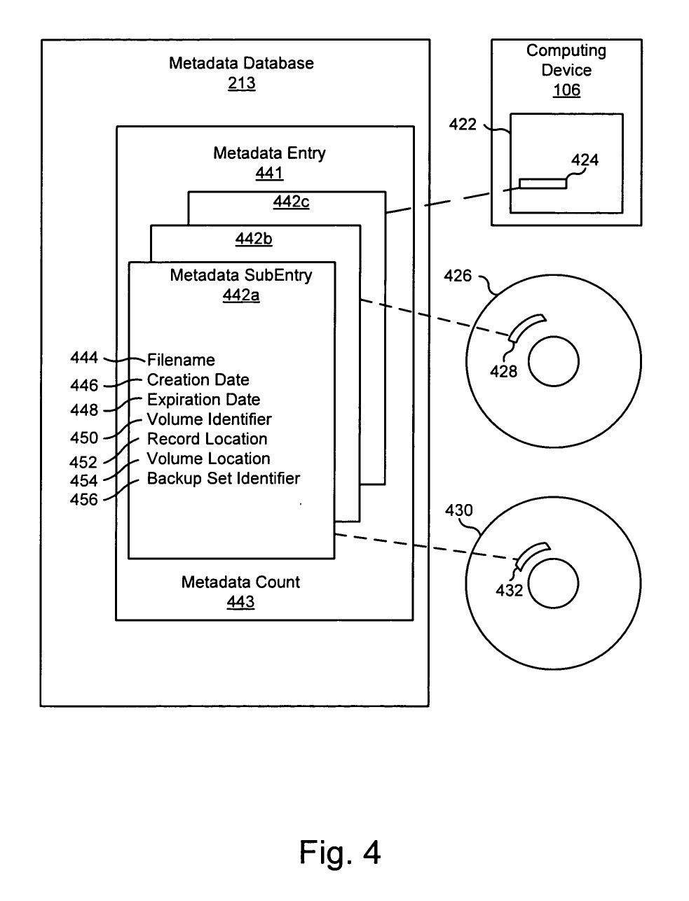

FIG. 4 illustrates one embodiment of a metadata database 213 of the metadata module 212. The metadata module 212 tracks various information about each backup copy 226 contained in the repositories 224 and stores that information in the metadata database 213. The metadata module 212 utilizes the metadata database 213 to provide location, version, and age information about available backup copies 226 to the various modules of the storage system 110.

The metadata database 213 comprises metadata entries 441. Each metadata entry 441 maps to a single file 104. For each file 104, several file copies 226 may exist. The metadata database 213 maintains the metadata entry 441 for a particular file 104 as long as one file copy 226 of the file 104 exists. For example, a system administrator may create two file copies 226 of a bank transaction log for Jan. 2, 2006. One file copy 226 may be stored in an online repository 301 while a second file copy 226 may be stored in an offline repository 304. Over time and according to policy, the bank may delete the online file copy 226 and retain the offline file copy 226. The metadata database 213 does not delete the metadata entry 441 related to the log until both file copies 226 have been deleted.

The metadata entry 441 keeps a metadata count 443 of the number of file copies 226 that exist. As a file copy 226 is deleted, the record deletion module 218 notifies the metadata module 212 of the deletion event and the metadata module 212 decrements the metadata count 443. Similarly, as new copies 226 of a file 104 are created, the metadata module 212 increments the metadata count 443 in response to a creation notification from the record creation module 214. The metadata database 213 preserves the metadata entry 441 for a given file 104 until the metadata count 443 equals zero, indicating that no outstanding file copies 226 exist. Those of skill in the art will understand that other mechanisms may be designed to accomplish the purpose of the metadata count 443 without departing from the spirit of the present invention, for example a linked list in the metadata database 213 representing file copies 226.

The metadata entry 441 may comprise one or more metadata subentries 442. Each metadata subentry 442 tracks information related to a single file copy 226. For example, the metadata subentry 442 may track the following data related to a file copy 226: a filename 444, a creation date 446, an expiration date 448, a volume identifier 450, a record location 452, a volume location 454, and the like. The filename 444 may save the original filename of an archived file 104. The creation date 446 may save the creation date of the backup copy 226. The expiration date 448 may indicate the date that the system will delete the file copy 226.

The volume identifier 450 may save a serial number or other identifier associated with a backup volume such as a computer tape serial number. The record location 452 may save an offset or other information necessary to locate the file on the backup volume. In many cases, a single computer tape 316 may store tens of thousands of file copies 226 and may require several minutes to search. The record location 452 may reduce the time required to locate a file copy 226 on a backup volume. The volume location 454 may save the physical or geographic location at which the volume is located including a city, state, storage bin 317 identifier, and a storage bin slot. The backup set identifier 456 may identify a backup repository 224 with a specific backup set or group of backup files.

In the illustrated embodiment of FIG. 4, a metadata entry 441 comprises three metadata subentries 442: 442a, 442b, 442c. The metadata entry 442a relates to an online RAM copy 424 of a particular file 104. In some cases, a storage system 110 may keep RAM copies 424 of files 104 for rapid access. The storage system 110 may be completely integrated with an enterprise storage system, treating even the latest copy 226 of a file 104 as a copy 226 to be tracked by the storage system 110. The RAM copy 424 is contained in the RAM 422 of a computing device 106.

In the illustrated embodiment, the metadata entry 442b relates to an optical disk copy 428 on an optical disk 426 of an online repository 301. The metadata entry 442b maintains the filename 444, the creation date 446, the expiration date 448, the volume identifier 450, the record location 452, the volume location 454, and the like pertaining to optical disk copy 428.

In the illustrated embodiment, the metadata entry 442c relates to a computer tape copy 432 on a computer tape 430 of an offline repository 304. The metadata entry 442c maintains similar information to that of metadata entry 442b. In this illustration, the metadata count 443 may be set to three to reflect the number of metadata subentries 442. As file copies 226 are deleted, the metadata database 213 deletes the corresponding metadata subentries 442 and decrements the metadata count 443. When the metadata count 443 equals zero, no more metadata subentries 442 remain related to the metadata entry 441 and the metadata database 213 may delete the metadata entry 441.

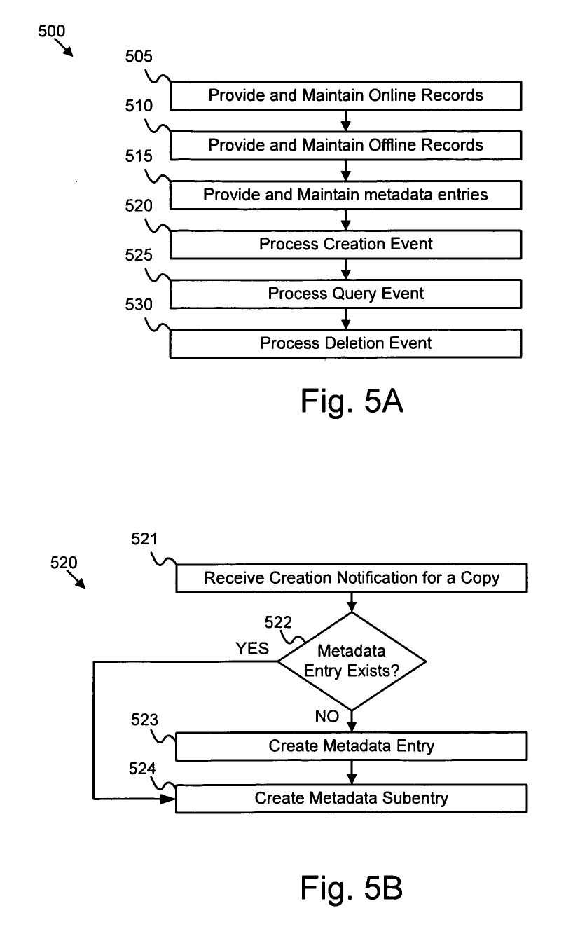

FIG. 5A illustrates a method 500 for maintaining metadata for offline repositories in online databases for efficient access. The method 500 comprises various functions including providing 505 and maintaining online records and providing 510 and maintaining offline records. The offline and online records may comprise one or more copies 226 of individual files 104. The method 500 may maintain the copies 226 as RAM copies 424 in the physical RAM 422 of a computing device 106. The method 500 may also maintain the copies 226 on a computer hard disk, on an optical disk 426, on a computer tape 430 or on other types of storage media.

The method 500 further comprises providing 515 and maintaining metadata entries 441 related to the various copies 226 stored on the various storage media. For each copy 226, providing 515 and maintaining metadata entries 441 may further comprise maintaining an metadata subentry 442 for each individual copy 226 of a file 104.

The method 500 further comprises processing 520 file creation events, processing 525 query events, and processing 530 file deletion events. The method 500 may receive notification of file creation events and file deletion requests. In some embodiments, the method 500 may include the actual deletion of files 104. However, in an alternative embodiment, the method 500 simply receives notifications of creation events and deletion events related to actual repositories 224. The method 500 processes 520, 525, 530 creation events, query requests, and deletion events using the record creation module 214, the query processor module 216, and the record deletion module 218, respectively.

FIG. 5B illustrates one embodiment of the processing 520 that the method 500 implements for file creation events. Upon receiving 521a file creation notification event, the record creation module 214 may query 522 the metadata module 212 to determine if a metadata entry 441 exists for the newly created file copy 226. If no metadata entry 441 exists, the record creation module 214 signals the metadata module 212 to create 523 a new metadata entry 441. Subsequently, the metadata module 212 may create 524 a new metadata subentry 442 for the new copy 226. The record creation module 214 may optionally create an actual file copy 226. However, the record creation module 214 may simply process the creation notification event subsequent to the creation of a file copy 226.

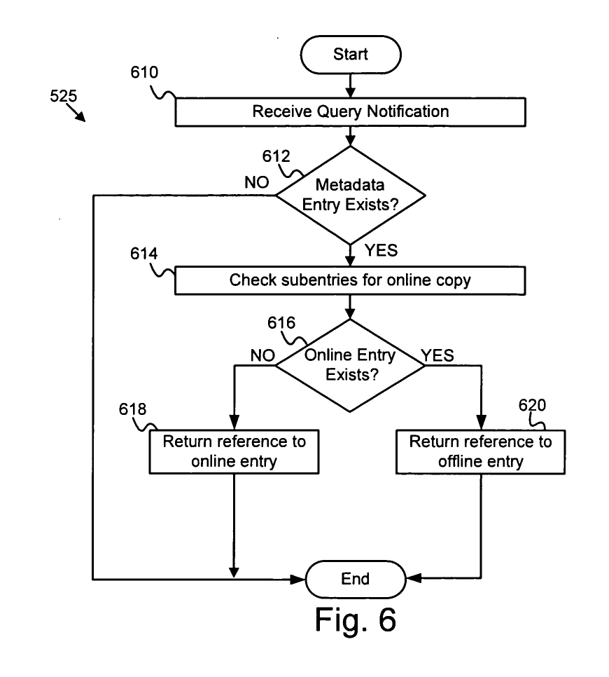

FIG. 6 illustrates one embodiment of the processing 525 that the method 500 implements in response to a file query request. Upon receiving 610 a file query event, the query processor module 216 may query 612 the metadata module 212 to determine if a metadata entry 441 exists for the file 104 in question. The metadata module 212 may further check 614 for metadata subentries 442.

The metadata module 212 may first determine 616 if an online copy 226 of the desired file 104 exists. If an online file copy 226, the query processor module 216 may return 618 a reference to the associated metadata subentry 442. If no online file copy 226 exists, the query processor module 216 may return a reference to metadata subentry 442 associated with an offline file copy 226. In one embodiment, the query processor module 216 may return all current information about all copies 226, or alternatively, the query processor module 216 may simply return a reference to the file copy 226 that best fulfills the query parameters, for example the most recent file copy 226, or the most recent file copy 226 that was created prior to a specific date.

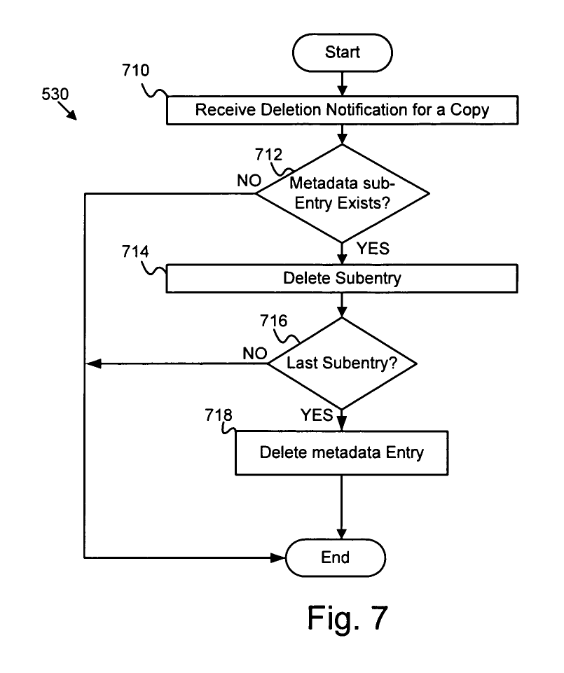

FIG. 7 illustrates one embodiment of the processing 530 of a file deletion event. The record deletion module 218 receives 710 a file deletion event. The record deletion module 218 may manage the actual deletion of file copies 226 or, alternatively, may simply process deletion events and coordinate the maintenance of metadata entries 441 and metadata subentries 442 with the metadata module 212.

Upon receipt 710 of a deletion event, the record deletion module 218 queries 712 the metadata module 212 to determine if a metadata entry 441 exists for the deleted file copy 226. If no metadata entry 441 exists, the record deletion module 218 terminates processing of the event. However, if a metadata entry 441 exists, the record deletion module 218 directs the metadata module 212 to delete 714 the associated metadata subentry 442. The metadata module 212 may decrement the metadata count 443. The metadata module 212 determines 716 if no more metadata subentry 442 exist or alternatively if the metadata count 443 is equal to zero, showing that the last metadata subentry 442 has been deleted. Upon deleting the last metadata subentry 442, the metadata module 212 deletes 718 the metadata entry 441 and processing terminates.

In an alternative embodiment, the logic to maintain the metadata entry 441 as long as at least one file copy 226 exists in one of the repositories 224 may be implemented in a metadata preservation module as part of the metadata module 212. The metadata preservation module ensures that the references to a file 104 are not deleted until all file copies 226 have been deleted.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to manage metadata pertaining to copies of files, the apparatus comprising:
one or more copies of a data record wherein at least one of the data record copies is stored on an offline storage medium;
a metadata module configured to maintain metadata pertaining to the one or more data record copies; and
a query processor module configured to retrieve metadata pertaining to the one or more data record copies in accordance with the metadata stored in the metadata module.

2. The apparatus of claim 1, the apparatus further comprising:
a record creation module configured to notify the metadata module of record creation events; and
a record deletion module configured to notify the metadata module of record deletion events.

3. The apparatus of claim 2, wherein the metadata module is further configured to maintain metadata pertaining to one or more data records by:
incrementing a count of the number of copies of the data record in response to receiving a record creation event for a data record;
decrementing the count in response to receiving a record deletion event for the data record; and
deleting the metadata for the data record in response to decrementing the count to zero.

4. The apparatus of claim 1, wherein the metadata module is further configured to maintain metadata pertaining to one or more data records by:
tracking the one or more copies of the data record; and
deleting the metadata pertaining to the one or more data record copies in response to the deletion of the last copy of the data record.

5. The apparatus of claim 1, wherein the metadata module is further configured to prevent the deletion of the metadata pertaining to the one or more data record copies in response to the deletion of a copy of the data record that is not the last copy of the data record.

6. The apparatus of claim 1, wherein the offline storage medium is selected from the group consisting of a computer tape accessible from an automated tape library, a computer tape inaccessible from an automated tape library, a compact disc (CD), a digital video disc (DVD), an optical drive, a removable hard disk, a floppy disk, and a universal serial bus storage device.

7. The apparatus of claim 1, wherein, for each of the one or more copies of the data record, the metadata comprises:
a filename;
a creation date;
an expiration date;
a volume identifier; and
a volume location.

8. The apparatus of claim 7, further comprising a restore module configured to selectively restore the data record in response to a restoration request.

9. The apparatus of claim 8, wherein the restore module is further configured to selectively restore the data record in accordance with a specified date value.

10. A signal bearing medium tangibly embodying a program of machine-readable instructions executable by a digital processing apparatus to perform operations to retrieve data from a plurality of data repositories, the operations comprising:
maintaining an online repository of data records maintaining an offline repository of data records;
maintaining an online metadata entry associating one or more copies of a data record, wherein at least one of the one or more copies is maintained in the offline repository;
retrieving a copy of the data record in accordance with the metadata entry.

11. The signal bearing medium of claim 10, wherein the operation further comprises deleting a copy of the data record in response to a deletion request; updating the online metadata entry to reflect the deletion of the copy; and deleting the metadata entry in response to the deletion of the last copy of the data record.

12. The signal bearing medium of claim 10, wherein the offline repository comprises computer tape volumes.

13. The signal bearing medium of claim 10, wherein the online metadata entry for each copy of the data record comprises:
a filename;
a creation date;
an expiration date;
a volume identifier;
a volume location; and
a backup set name.

14. The signal bearing medium of claim 11, wherein the online metadata entry is stored in a metadata database.

15. A system for managing metadata pertaining to copies of files the system comprising:
a computer network;
an online storage repository connected to the computer network and configured to store an online copy of a file;
an offline storage repository configured to store storage volumes;
a storage device connected to the computer network and configured to store an offline copy of the file on a storage volume in the offline storage repository;
an online metadata database;
a metadata module configured to maintain in the online metadata database metadata pertaining to the online copy and metadata pertaining to the offline copy;
a query processor module configured to retrieve metadata from the online metadata database pertaining to the online copy and the offline copy; and
a metadata preservation module configured to prevent the deletion of metadata pertaining to the file prior to the deletion of the online copy and the offline copy.

16. The system of claim 15, the system further comprising:
a record creation module configured to notify the metadata module of record creation events; and
a record deletion module configured to notify the metadata module of record deletion events.

17. The system of claim 15, wherein the metadata module is further configured to maintain metadata pertaining to one or more data records by:
incrementing a count of the number of copies of the data record in response to receiving a record creation event for a data record;
decrementing the count in response to receiving a record deletion event for the data record; and
deleting the metadata for the data record in response to decrementing the count to zero.

18. The system of claim 15, wherein the metadata module is further configured to maintain metadata pertaining to one or more data records by:
tracking the one or more copies of the data record; and
deleting the metadata pertaining to the one or more data record copies in response to the deletion of the last copy of the data record.

19. A method for managing metadata pertaining to copies of files, the method comprising:
maintaining an online repository of data records
maintaining an offline repository of data records;
maintaining an online metadata entry associating one or more copies of a data record, wherein at least one of the one or more copies is maintained in the offline repository;
retrieving a copy of the offline data record in accordance with the online metadata entry.

20. The method of claim 19, the method further comprising preventing the deletion of the online metadata entry pertaining to the one or more data record copies in response to the deletion of a copy of the data record that is not the last copy of the data record.
